(19) United States
(12) Patent Application Publication
(10) Pub. No.: US 2007/0215541 A1
(43) Pub. Date: Sep. 20, 2007

(54) Hydrocyclone oil/sand/water separating apparatus

(76) Inventor: Hans-Peter Kampfer, Herborn (DE)

Correspondence Address: K.F. ROSS P.C., 5683 RIVERDALE AVENUE, SUITE 203 BOX 900, BRONX, NY, 10471-0900, US

(21) Appl. No.: 10/645,337

(22) Filed: Aug. 21, 2003

(30) Foreign Application Priority Data
Aug. 24, 2002 (DE) 10239359.1

(51) Int. Cl. B01D 21/26

(52) U.S. Cl. 210/512.2

(57) ABSTRACT

A hydrocyclone separating apparatus has a housing subdivided into a central chamber provided with an input port and a pair of end chambers having respective outlet ports. A plurality of hydrocyclones extend across the central chamber between the end chambers. The hydrocyclones each have an intake in the central chamber and an end output in each of the output chambers. A fluent mixture pumped via the input port into the central chamber is separated by the hydrocyclones into a light fraction exiting one of the end chambers from the respective outlet port and a heavy fraction exiting the other of the end chambers from the respective outlet port. A layer of low-friction durable material such as polytetrafluoroethylene is provided on outer surfaces of the hydrocyclones in the central chamber.

### FIELD OF THE INVENTION

The present invention relates to a separating apparatus. More particularly this invention concerns a separating apparatus having a plurality of hydrocyclones serving, for instance, for separating oil, sand, and water in an offshore drilling operation.

### BACKGROUND OF THE INVENTION

A typical hydrocyclone separating apparatus as described in U.S. Pat. No. 5,667,687 of Lange has a housing subdivided into a central chamber provided with an input port and a pair of end chambers having respective outlet ports. A plurality of hydrocyclones as described in U.S. Pat. No. 3,724,674 is of Loison and U.S. Pat. No. 3,988,239 of Malina as well as in British patent document 2,214,841 of Hill extend across the central chamber between the end chambers. These hydrocyclones each have an intake in the central chamber and an end output in each of the output chambers.

In such an apparatus a fluent mixture, e.g. a sand/oil/water slurry, pumped via the input port into the central chamber is separated by the hydrocyclones into a light fraction, e.g. the oil, exiting one of the end chambers from the respective outlet port and a heavy fraction, e.g. the sand and water, exiting the other of the end chambers from the respective outlet port. Such a system can effectively recover the valuable while leaving the oil content of the sand/water mixture low enough as to constitute no environmental risk.

The problem with these arrangements is that the slurry can cake on the outer surfaces of the relatively closely packed hydrocyclones in the central chamber. Here the slurry is moving at slow speed so it has time to deposit, unlike inside the cyclone tubes where there is a self-scouring action. It has been suggested that these deposits can simply be flushed off the hydrocyclones (see above cited patent U.S. Pat. No. 5,667,687), but this procedure is only minimally effective and in the long run hard deposits form that cannot be removed by simple back flushing.

Two other solutions have been suggested. One is simply to replace the entire apparatus when the hydrocyclones become to caked, perhaps cleaning and refitting the apparatus taken out of service by physically scraping off the deposits. In another the deposit-laden parts of the cyclones are clad with removable covers so that these covers can be removed, along with the deposits. Both these latter solutions require considerable down time for the changeover or service work.

### OBJECTS OF THE INVENTION

It is therefore an object of the present invention to provide an improved hydrocyclone separating apparatus.

Another object is the provision of such an improved hydrocyclone separating apparatus which overcomes the above-given disadvantages, that is which is less prone to form deposits on the hydrocyclones and/or that is easier to clean of such deposits.

### SUMMARY OF THE INVENTION

A hydrocyclone separating apparatus has according to the invention a housing subdivided into a central chamber provided with an input port and a pair of end chambers having respective outlet ports. A plurality of hydrocyclones extend across the central chamber between the end chambers. The hydrocyclones each have an intake in the central chamber and an end output in each of the output chambers. A fluent mixture pumped via the input port into the central chamber is separated by the hydrocyclones into a light fraction exiting one of the end chambers from the respective outlet port and a heavy fraction exiting the other of the end chambers from the respective outlet port. A layer of low-friction durable material is provided on outer surfaces of the hydrocyclones in the central chamber.

The layer of wear-resistant low-friction material makes it very difficult for particles to deposit on the outer surfaces of the hydrocyclones. Such deposits will not form so that the spaces between the hydrocyclones will remain open. Only over an extremely long time will such deposits form, and the reason to replace the hydrocyclones might be more the problem of wear on the inside surfaces than the buildup of deposits on the outside surfaces.

In accordance with the invention the material is polytetrafluoroethylene, also known as Teflon™. Such a coating is so resistant to deposits that it can normally be cleaned by a simple back-flushing operation.

The layer has a thickness of at least 8 μm, normally about 17 μm. To maximize the deposit-resisting characteristics, it is plastic and includes film-forming resins and/or mineral fillers.

In order to ensure good bonding to the surface of the hydrocyclones, before applying the low-friction coating the outside surfaces of the cyclones are roughened. This can be done by laser treatment or etching. Alternately the outer surface is roughened by an application of thermally applied hard granules.

### BRIEF DESCRIPTION OF THE DRAWING

The above and other objects, features, and advantages will become more readily apparent from the following description, reference being made to the accompanying drawing in which:

FIG. 1 is a vertical section through the separating apparatus according to the invention; and

FIG. 2 is a side view of an individual hydrocyclone of the apparatus of FIG. 1.

### SPECIFIC DESCRIPTION

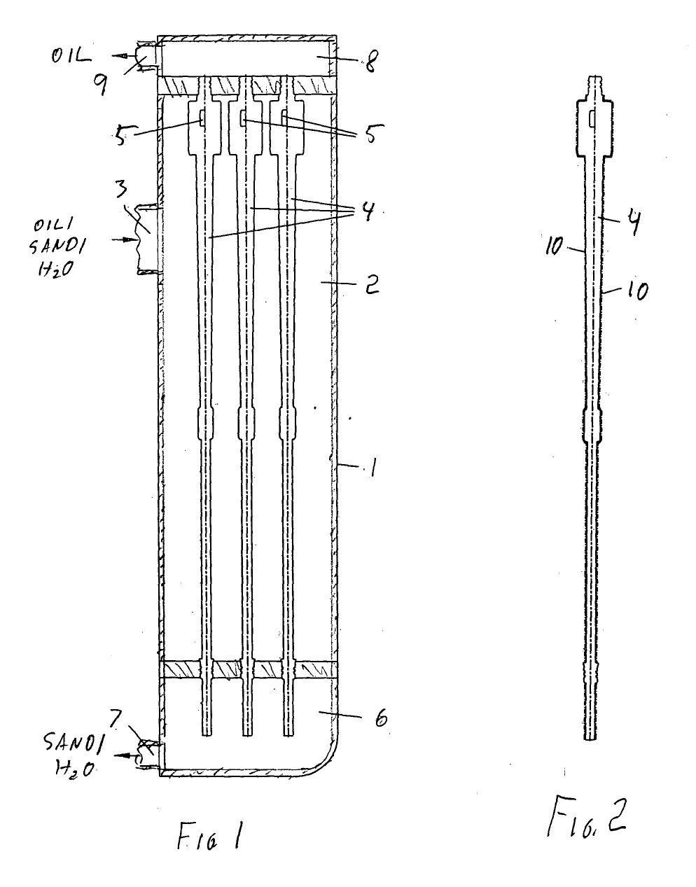

As seen in FIG. 1 a separating apparatus in accordance with the invention has a housing 1 defining a central input chamber 2 having an input port 3 for an oil/sand/water slurry, a lower end chamber 6 with an outlet port 7 for sand and water, and an upper end chamber 8 with an outlet port 9 for oil. Individual basically tubular and downwardly tapering hydrocyclones 4 have upper ends opening into the chamber 8 and lower ends opening into the chamber 6. At the upper region of the chamber 2, the wide upper ends of the hydrocyclones 4 have tangentially directed intakes 5. The system could of course also be operated with the hydrocyclones 4 horizontal.

Thus with this system the oil/sand/water slurry is pumped into the inlet port 3 so as to fill and pressurize the central chamber 2 around the hydrocyclones 4. This slurry enters the hydrocyclones 4 in the upper end of the chamber 2 via the intakes 5 that ensure cyclonic flow and separation inside the individual hydrocyclones 4 as is well known in the art, having the effect of separating the heavy fraction—here water and sand—from the light fraction—here oil. The water and sand move from the lower ends of the hydrocyclones 4 into the lower outlet chamber 6 and out the port 7, and the oil is recovered from the upper outlet chamber 8 via the port 9. This is all generally standard.

In accordance with the invention as shown in FIG. 2, the outer surfaces of each of the cyclones are coated in the chamber 2 with a layer 10 of a highly durable but very smooth low-friction coating, here polytetrafluoroethylene about 17 μm thick.

In order to ensure good adherence of the layer 10 to the outer surfaces of the hydrocyclones 4, these outer surfaces are roughened before the layer 10 is applied. This roughening can be done by a laser treatment, by etching, or by coating with hard granules.

I claim:

1. A hydrocyclone separating apparatus comprising:
a housing subdivided into a central chamber provided with an input port and a pair of end chambers having respective outlet ports;
a plurality of hydrocyclones extending across the central chamber between the end chambers, the hydrocyclones each having an intake in the central chamber and an end output in each of the output chambers, whereby a fluent mixture pumped via the input port into the central chamber is separated by the hydrocyclones into a light fraction exiting one of the end chambers from the respective outlet port and a heavy fraction exiting the other of the end chambers from the respective outlet port; and
a layer of low-friction durable material coating outer surfaces of the hydrocyclones in the central chamber.

2. The hydrocyclone separating apparatus defined in claim 1 wherein the material is polytetrafluoroethylene.

3. The hydrocyclone separating apparatus defined in claim 2 wherein the layer has a thickness of at least 8 μm.

4. The hydrocyclone separating apparatus defined in claim 2 wherein the layer has a thickness of about 17 μm.

5. The hydrocyclone separating apparatus defined in claim 1 wherein the layer is plastic and includes film-forming resins.

6. The hydrocyclone separating apparatus defined in claim 1 wherein the layer is plastic and the layer includes mineral fillers.

7. The hydrocyclone separating apparatus defined in claim 1 wherein the outer surface underneath the layer is roughened.

8. The hydrocyclone separating apparatus defined in claim 7 wherein the outer surface is laser-roughened.

9. The hydrocyclone separating apparatus defined in claim 7 wherein the outer surface is roughened by etching.

10. The hydrocyclone separating apparatus defined in claim 7 wherein the outer surface is roughened by application of thermally sprayed-on hard granules.
